(19) United States
(12) Patent Application Publication
(10) Pub. No.: US 2026/0361620 A1
(43) Pub. Date: Nov. 12, 2026

(54) SYSTEMS AND METHODS FOR GENERATING, REVIEWING, AND DEPLOYING METHOD OF PROCEDURE DATA

(71) Applicant: T-MOBILE INNOVATIONS LLC, Overland Park, KS (US)

(72) Inventors: Vikas RANJAN, Bellevue, WA (US); Anand Samuel INJETI, Snoqualmie, WA (US); Hector Ernesto PEREZ, Wesley Chapel, FL (US); Elywin Edward DAWKINS, Prosper, TX (US); Jyothi Kiran MUPPAVARAPU, Mckinney, TX (US); Raymond Weimin WU, Newcastle, WA (US); Sridhar BETHAMSETTY, Frisco, TX (US); Shalini SELVARAJ, Snoqualmie, WA (US)

(21) Appl. No.: 19/074,037

(22) Filed: Mar. 7, 2025

(51) Int. Cl. H04L 41/50

(52) U.S. Cl. CPC H04L 41/50

(57) ABSTRACT

The process of generating, reviewing, and deploying Method of Procedure (MOP) data in a communications network is largely manual, time-intensive, and prone to errors, often causing delays and outages. To address these inefficiencies, AI-driven automation can streamline MOP workflows by integrating with network management systems to dynamically generate, review, and deploy MOPs. AI agents can handle pre-checks, execution, and root cause analysis, reducing human intervention and downtime. An orchestration framework can manage agent interactions, improving accuracy, efficiency, and reliability while helping enable faster failure resolution and minimizing operational disruptions in large-scale network environments.

### SUMMARY

The present disclosure is directed, in part, to deploying Method of Procedure (MOP) data in a communications network, substantially as shown and/or described in connection with at least one of the figures, and as set forth more completely in the claims.

According to various aspects of the technology, the process of generating, reviewing, and deploying MOP data a communications network is largely manual and time-intensive. When network changes are required, engineers first identify the specific tasks or configurations needed, such as adding new devices, updating software, or modifying network settings. This information is manually compiled into a MOP document and proceeds through multiple teams before eventually being deployed. During deployment, issues such as errors in configuration or unforeseen circumstances can lead to failures, requiring engineers to manually investigate logs, identify root causes, and devise fixes. This process often involves coordinating multiple teams and delaying resolutions. This approach is time-consuming, prone to human error, and can result in outages or delays, particularly in large-scale or complex networks.

To address the inefficiencies and challenges of current MOP processes, concepts discussed herein may leverage artificial intelligence (AI) and automation to streamline the generation, review, and deployment of MOP data. For example, by integrating AI-powered tools (e.g., AI-driven agents) with existing network management systems, such as configuration databases, change request (CR) platforms, and/or IP management systems, these tools can dynamically pull relevant data to generate comprehensive, contextually accurate MOPs. These documents may include pre-check, implementation, post-check, and rollback procedures tailored to specific network tasks. This minimizes the need for human intervention and reduces downtime. Additionally, orchestration frameworks may be implemented to manage the interaction of multiple AI agents, including MOP generation, review, deployment, and root cause analysis (RCA) agents. By implementing such methods, the accuracy, efficiency, and overall reliability of network operations may be significantly enhanced by reducing human error and enabling faster response times to failures.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE DRAWINGS

FIG. 1 illustrates an exemplary computing device for use with the present disclosure;

FIG. 2 illustrates a diagram of an exemplary network environment in which implementations of the present disclosure may be employed;

FIG. 3 illustrates an example flow diagram in which implementations of the present disclosure may be employed; and

FIG. 4 illustrates a flow chart of an exemplary method for which implementations of the present disclosure may be employed.

### DETAILED DESCRIPTION

By way of background, in a communications network, deploying MOP data is an important process that helps ensure the proper implementation of changes, updates, or maintenance activities across the network infrastructure. This process involves multiple step, each of which is carefully designed to minimize disruptions and ensure the reliability of the network. Typically, the MOP deployment begins after the MOP document has been reviewed and approved by the relevant teams, such as engineering and quality assurance. The document may outline detailed instructions for executing planned changes, including pre-checks, implementation procedures, post-checks, and rollback steps in case of failure. The deployment may begin with pre-checks, where the team ensure that the network is ready to handle the proposed changes. Once the pre-checks are completed successfully, the team may proceed with implementing the changes outlined in the MOP. This can involve a wide range of activities, such as updating device configurations, installing or upgrading software, modifying routing or traffic policies, or adding new hardware components to the network. Issues can arise during this phase if the MOP is incomplete, ambiguous, or does not account for certain network conditions, which may lead to partial or complete failure of the deployment.

After the changes are applied, the team may perform post-checks to verify that the implementation was successful and that the network is functioning as expected. Post-checks may include testing connectivity, monitoring traffic, validating device performance, and confirming that the changes did not introduce new issues. If any discrepancies are found during the post-checks, the team must quickly diagnose the problem and decide whether to proceed, roll back the changes, or apply additional fixes. Another important aspects in deploying MOP data is managing failures effectively. In some cases, rollback procedures defined in the MOP must be executed to restore the network to its original configuration. However, rollbacks are not always straightforward, especially in complex network environments where dependencies and interactions between devices are not fully documented or understood. Furthermore, diagnosing the root cause of a failure can be time-consuming, often requiring collaboration across multiple teams and manual analysis of logs and error messages.

To address the challenges of deploying MOP data in a communications network, aspects of the present disclosure may focus on leveraging AI, machine learning, and/or automation to create a more reliable and efficient process. These improvements aim to reduce the reliance on manual processes, minimize human error, and enhance the speed and accuracy of network deployments. By introducing automation and AI at key stages (e.g., generation, review, deployment, and troubleshooting), networks can achieve greater operational resilience and responsiveness to changes.

At the generation stage, AI-powered tools may be utilized to automate the creation of MOP documents. By integrating with network management systems (e.g., ServiceNow for CRs, configuration databases, and IP address management systems), these tools can dynamically retrieve data about the network's current state, devices involved, and the specific changes required. AI models trained on historical MOP data can generate highly detailed and accurate MOP documents, including pre-checks, step-by-step implementation commands, post-checks, and rollback plans. These models ensure consistency in formatting and terminology, reducing ambiguities and omissions that often lead to errors. This automation significantly reduces the workload for engineers, enabling them to focus on more strategic tasks.

At the review stage, an AI-driven review process can be implemented. The AI model evaluates the generated MOP against best practices, operational policies, and known failure patterns from historical data. It can flag missing or inconsistent steps, check for security vulnerabilities, and verify compliance with configuration standards. Advanced machine learning algorithms can analyze potential risks by simulating how the proposed changes would affect the network in a test environment. While human review may remain as part of the process, the AI system significantly reduces the time required by preemptively identifying and addressing issues.

At the deployment stage, once the MOP is approved, automated deployment agents may execute the defined steps with precision. These agents leverage APIs, command-line interfaces, or orchestration tools to interact directly with network devices and systems. Automation eliminates the risk of errors due to manual execution, such as mistyped commands or skipped steps. During deployment, real-time monitoring systems track logs, device status, and network performance metrics. AI-powered monitoring tools can identify deviations from expected behavior, triggering alerts or taking corrective action when anomalies are detected. For example, if a device fails to respond during a configuration update, the system can pause the deployment, assess the issue, and implement a rollback if necessary.

At the troubleshooting stage, AI may be integrated for RCA and autonomous recovery. For example, when a failure occurs, AI agents analyze error logs, system alerts, and historical data to identify the underlying cause. By using natural language processing (NLP) and advanced analytics, these agents can generate a detailed diagnosis, pinpointing specific commands, devices, or configurations responsible for the issue. In many cases, the system can autonomously apply fixes, such as retrying failed commands with adjusted parameters or correcting configuration errors based on predefined rules. For more complex issues, the AI generates recommendations for human review, expediting the troubleshooting process.

To coordinate in a multi-agent framework, a centralized orchestration framework may coordinate the activities of multiple AI agents involved in MOP generation, review, deployment, and RCA. This framework helps ensure seamless handoffs between stages, maintains a complete audit trail of actions, and facilitates communication between agents. For instance, if a deployment agent encounters a failure, it can immediately notify the RCA agent, which then analyzes the issue and provides feedback to the deployment agent or the review team. This orchestrated approach enables the network to respond dynamically to challenges while maintaining operational continuity. Furthermore, machine learning may be used to continuously improve the AI systems. By training models on historical MOP documents, deployment outcomes, and failure patterns, the system becomes increasingly accurate over time. Data from failed deployments is particularly valuable, as it provides insights into edge cases and exceptions that can be used to refine the AI's decision-making processes. Additionally, domain-specific prompt libraries allow teams to customize the AI's behavior for specific network environments, ensuring that the solutions are highly relevant to their unique operational needs.

By automating repetitive tasks and introducing AI-driven insights, these solutions address key pain points in MOP deployment. They minimize human error, reduce the time required for reviews and deployments, and enable faster recovery from failures. This leads to fewer network outages, better customer experience, and lower operational costs. Furthermore, the ability to proactively detect and resolve issues reduces the likelihood of prolonged downtime, enhancing the overall reliability and resilience of the network.

Accordingly, a first aspect of the present disclosure is directed to a system for generating, reviewing, and deploying Method of Procedure (MOP) data in a communications network. The system includes a network device comprising one or more processors. The system further includes a non-transitory computer-readable media configured to, by a retrieval agent, accessing network-related data from one or more network management systems. The computer-readable media is further configured to, by a document generation agent, generating a MOP document based on the accessed data. The computer-readable media is further configured to, by a review agent, evaluate and approve the generated MOP document. The computer-readable media is further configured to, by a deployment agent, executing the MOP document. The computer-readable media is further configured to, by a root cause analysis agent, in response to a detected error during the execution of the MOP document, analyzing logs and error data to determine a root cause. The computer-readable media is further configured to, by an orchestration framework, coordinating the operations of the data retrieval agent, the document generation agent, and the deployment agent.

A second aspect of the present disclosure is directed to a non-transitory computer readable media having computer-executable instructions stored thereon that, when executed by one or more computer processor components, cause the one or more computer processing components to perform operations for generating, reviewing, and deploying Method of Procedure (MOP) data in a communications network. The computer-readable media is configured to, by a retrieval agent, accessing network-related data from one or more network management systems. The computer-readable media is further configured to, by a document generation agent, generating a MOP document based on the accessed data. The computer-readable media is further configured to, by a review agent, evaluate and approve the generated MOP document. The computer-readable media is further configured to, by a deployment agent, executing the MOP document. The computer-readable media is further configured to, by a root cause analysis agent, in response to a detected error during the execution of the MOP document, analyzing logs and error data to determine a root cause. The computer-readable media is further configured to, by an orchestration framework, coordinating the operations of the data retrieval agent, the document generation agent, and the deployment agent.

A third aspect of the present disclosure is directed to a method for generating, reviewing, and deploying Method of Procedure (MOP) data. The method includes, by a retrieval agent, accessing network-related data from one or more network management systems. The method further includes, by a document generation agent, generating a MOP document based on the accessed data. The computer-readable media is further configured to, by a review agent, evaluate and approve the generated MOP document. The method further includes, by a deployment agent, executing the MOP document. The method further includes, by a root cause analysis agent, in response to a detected error during the execution of the MOP document, analyzing logs and error data to determine a root cause. The method further includes, by an orchestration framework, coordinating the operations of the data retrieval agent, the document generation agent, and the deployment agent.

The subject matter of embodiments of the invention is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Various technical terms, acronyms, and shorthand notations are employed to describe, refer to, and/or aid the understanding of certain concepts pertaining to the present disclosure. Unless otherwise noted, said terms should be understood in the manner they would be used by one with ordinary skill in the telecommunication arts. An illustrative resource that defines these terms can be found in Newton's Telecom Dictionary, (e.g., 32d Edition, 2022).

The example aspects and embodiments described in the present disclosure are provided within the context of a wireless telecommunication network for illustrative purposes. However, it should be understood that the principles and techniques discussed herein are not limited to wireless networks alone. The concepts and methodologies can be equally applied to other types of communication networks, including but not limited to wired, satellite, and optical networks. These alternative networks are capable of supporting the functionalities and applications described, and their use falls within the scope of the present disclosure.

As used herein, a “MOP document” may refer to a structured and detailed set of instructions used in a communications network to guide the execution of network changes, maintenance activities, and system updates in a controlled and repeatable manner. The MOP document helps ensure that network modifications are carried out systematically, minimizing the risk of errors, service disruptions, or security vulnerabilities. A well-defined MOP document contains MOP data, which includes both procedural instructions and contextual metadata essential for accurate execution, validation, and rollback operations.

As used herein, a “Change Request (CR)” in the context of a communications network, such as a ServiceNow CR, may be a formal record that documents a proposed modification to network infrastructure, software, configurations, or operational procedures. The CR may serve as a structured mechanism for tracking, reviewing, approving, and implementing changes while maintaining compliance with organizational policies and minimizing service disruptions. CRs may be utilized for Change Management, helping ensure that all network modifications are performed in a controlled, auditable, and standardized manner.

As used herein, an “AI agent” may refer to an intelligence component designed to perform specific tasks autonomously or in coordination with other agents to streamline network management processes. These agents may leverage artificial intelligence (AI), machine learning (ML), natural language processing (NLP), and automation frameworks to execute predefined functions with minimal human intervention. AI agents may be designed to operate within an orchestration framework, allowing seamless communication and collaboration among multiple agents to handle complex network operations such as data retrieval, document generation, document review, deployment execution, and root cause analysis (RCA).

As used herein, an “orchestration framework” may refer to a centralized control system that manages, coordinates, and synchronizes the operations of multiple AI agents, automation processes, and network management tasks. It may serve as the command and control layer that helps ensure seamless execution of complex workflows, helping enable efficient interaction between various AI-driven components such as retrieval agents, document generation agents, document review agents, deployment agents, and root cause analysis (RCA) agents. By handling the complexities of multi-agent coordination, an orchestration framework helps enable automated, scalable, and intelligent network management.

Embodiments of the technology described herein may be embodied as, among other things, a method, system, or computer-program product. Accordingly, the embodiments may take the form of a hardware embodiment, or an embodiment combining software and hardware. An embodiment takes the form of a computer-program product that includes computer-useable instructions embodied on one or more computer-readable media that may cause one or more computer processing components to perform particular operations or functions.

Computer-readable media include both volatile and nonvolatile media, removable and nonremovable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions—including data structures and program modules—in a modulated data signal. The term “modulated data signal” refers to a propagated signal that has one or more of its characteristics set or changed to encode information in the signal. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

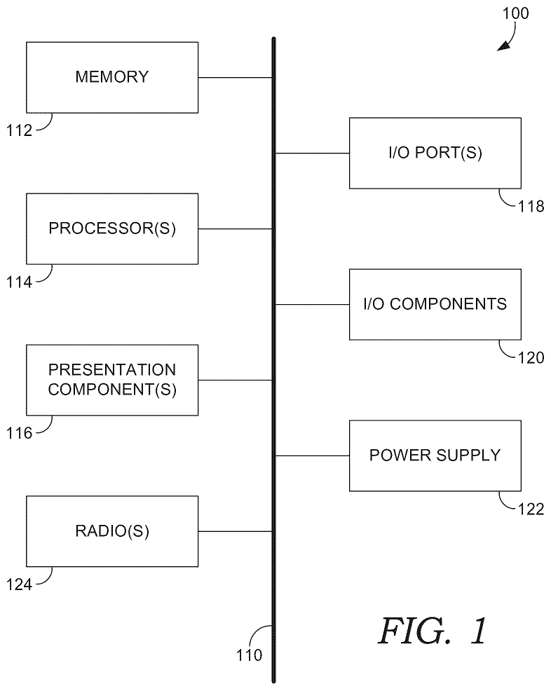

Referring to FIG. 1, an exemplary computer environment is shown and designated generally as computing device 100 that is suitable for use in implementations of the present disclosure. Computing device 100 is but one example of a suitable computing environment and is not intended to suggest any limitation as to the scope of use or functionality of the invention. Neither should computing device 100 be interpreted as having any dependency or requirement relating to any one or combination of components illustrated. In aspects, the computing device 100 is generally defined by its capability to transmit one or more signals to an access point and receive one or more signals from the access point (or some other access point); the computing device 100 may be referred to herein as a user equipment (UE), wireless communication device, or user device, The computing device 100 may take many forms; non-limiting examples of the computing device 100 include a fixed wireless access device, cell phone, tablet, internet of things (IoT) device, smart appliance, automotive or aircraft component, pager, personal electronic device, wearable electronic device, activity tracker, desktop computer, laptop, PC, and the like.

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

With continued reference to FIG. 1, computing device 100 includes bus 102 that directly or indirectly couples the following devices: memory 104, one or more processors 106, one or more presentation components 108, input/output (I/O) ports 110, I/O components 112, and power supply 114. Bus 102 represents what may be one or more busses (such as an address bus, data bus, or combination thereof). Although the devices of FIG. 1 are shown with lines for the sake of clarity, in reality, delineating various components is not so clear, and metaphorically, the lines would more accurately be grey and fuzzy. For example, one may consider a presentation component such as a display device to be one of I/O components 112. Also, processors, such as one or more processors 106, have memory. The present disclosure hereof recognizes that such is the nature of the art, and reiterates that FIG. 1 is merely illustrative of an exemplary computing environment that can be used in connection with one or more implementations of the present disclosure. Distinction is not made between such categories as “workstation,” “server,” “laptop,” “handheld device,” etc., as all are contemplated within the scope of FIG. 1 and refer to “computer” or “computing device.”

Computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes RAM, ROM, EEPROM, flash memory or other memory technology, CD-ROM, digital versatile disks (DVD) or other optical disk storage, magnetic cassettes, magnetic tape, magnetic disk storage or other magnetic storage devices. Computer storage media of the computing device 100 may be in the form of a dedicated solid state memory or flash memory, such as a subscriber information module (SIM). Computer storage media does not comprise a propagated data signal.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 104 includes computer-storage media in the form of volatile and/or nonvolatile memory. Memory 104 may be removable, nonremovable, or a combination thereof. Exemplary memory includes solid-state memory, hard drives, optical-disc drives, etc. Computing device 100 includes one or more processors 106 that read data from various entities such as bus 102, memory 104 or I/O components 112. One or more presentation components 108 presents data indications to a person or other device. Exemplary one or more presentation components 108 include a display device, speaker, printing component, vibrating component, etc. I/O ports 110 allow computing device 100 to be logically coupled to other devices including I/O components 112, some of which may be built in computing device 100. Illustrative I/O components 112 include a microphone, joystick, game pad, satellite dish, scanner, printer, wireless device, etc.

The radio 120 represents one or more radios that facilitate communication with one or more wireless networks using one or more wireless links. While a single radio 120 is shown in FIG. 1, it is expressly contemplated that there may be more than one radio 120 coupled to the bus 102. In aspects, the radio 120 utilizes a transmitted to communicate with a wireless telecommunications network. It is expressly contemplated that a computing device 100 with more than one radio 120 could facilitate communication with the wireless network via both the first transmitter and additional transmitters (e.g. a second transmitter). Illustrative wireless telecommunications technologies include CDMA, GPRS, TDMA, GSM, and the like. The radio 120 may carry wireless communication functions or operations using any number of desirable wireless communication protocols, including 802.11 (Wi-Fi), WiMAX, LTE, 3G, 4G, LTE, 5G, NR, VoLTE, or other VoIP communications. As can be appreciated, in various embodiments, radio 120 can be configured to support multiple technologies and/or multiple radios can be utilized to support multiple technologies. A wireless telecommunications network might include an array of devices, which are not shown as to obscure more relevant aspects of the invention. Components such as a base station or communications tower (as well as other components) can provide wireless connectivity in some embodiments.

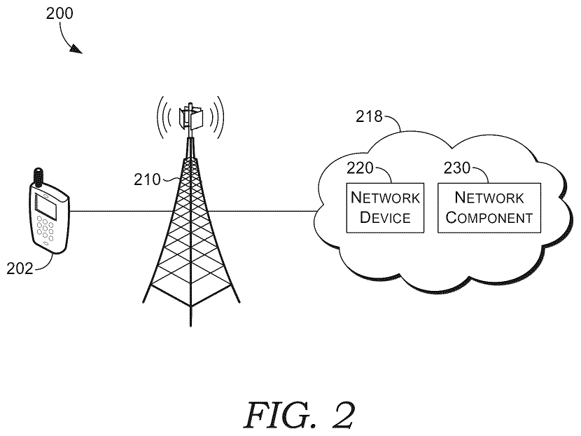

Referring now to FIG. 2, an exemplary network environment is illustrated in which implementations of the present disclosure may be employed. Such a network environment is illustrated and designated generally as network environment 200. Network environment 200 is but one example of a suitable network environment and is not intended to suggest any limitation as to the scope of use or functionality of the invention. Neither should the network environment be interpreted as having any dependency or requirement relating to any one or combination of components illustrated.

Network environment 200 represents a high level and simplified view of relevant portions of a modern wireless telecommunication network. At a high level, the network environment 200 may generally be said to comprise one or more UEs, such as UE 202, one or more base stations, such as a base station 210, a core network 218, a network device 220, and a network component 230, though in some implementations, it may not be necessary for certain features to be present. The network environment may include a number of routers, switches, and the like. The network environment 200 is generally configured for wirelessly connecting the UE 202 to data or services that may be accessible through the core network 218, or other functions, nodes, or servers not pictured in FIG. 2 so as to not obscure the focus on the present disclosure.

The UE 202 is illustrated generally, and may take any number of forms, including a tablet, phone, or wearable device, or any other device discussed with respect to FIG. 1 and may have any one or more components or features of the computing device 100 of FIG. 1. In some aspects, the UE 202 may not be a conventional telecommunications devices (i.e., a device that is capable of placing and receiving voice calls), but may instead take the form of devices that only utilizes wireless network resources in order to transmit or receive data; such devices may include IoT devices (e.g., smart appliances, thermostats, locks, smart speakers, lighting devices, smart receptacles, and the like).

The base station 210 may provide a network access location where the UE may potentially connect to (also referred to as ‘camping on,’ ‘attaching,’ in the industry). Though network environment 200 is illustrated with only the base station 210, one skilled in the art will appreciate that more or fewer base stations may be present in any particular network environment. The base station 210 is configured to wirelessly communicate with UEs, such as the UE 202. In aspects, the base station 210 may communicate with the UE 202 using any wireless telecommunication protocol desired by a network operator, including but not limited to 3G, 4G, 5G, 6G, 802.11x and the like.

The core network 218 may provide services and connectivity to the UE 202. For example, the core network 218 may manage the routing, authentication, and delivery of voice, data, and messaging services to the UE 202, regardless of whether the UE is operating within its home network. In some aspects, the core network 218 may include packet gateways and session management functions that help control the UE's 202 access to external data networks and multimedia services. For example, the core network 218 may communicate with the base station to provide services to the UE 202.

The network device 220 may be a centralized processing and coordination unit that facilitates the end-to-end lifecycle of MOP generation, review, and deployment in a communications network. This component may serve as the operational hub within the network automation ecosystem, integrating with various network management systems, AI agents, and orchestration frameworks to enable seamless execution of network changes. Broadly, network device 220 may be responsible for data aggregation, process execution, real-time monitoring, and failure management, helping ensure that network change management is carried out efficiently and with minimal disruption.

Network device 220 may house the intelligent automation engine, which governs MOP data processing, execution logic, and inter-agent communication. This engine may interface with key network management platforms, such as ServiceNow for Change Requests (CRs), Configuration Management Databases (CMDBs), and network telemetry systems, to collect and analyze relevant operational data. Using this data, the component may initiate the retrieval of configuration details, device status, and network topology information necessary for MOP generation. Additionally, network device 220 may incorporate AI-driven decision-making, enabling context-aware document generation, risk assessment, and anomaly detection before deployment.

During the MOP review process, network device 220 may help facilitate both AI-assisted validation and human oversight. It may employ automated rule-based checks, historical failure analysis, and security policy verification to detect inconsistencies, missing steps, or potential conflicts within a proposed MOP. The component may also integrate role-based access controls (RBAC) to ensure that only authorized personnel can approve or modify MOP documents, maintaining compliance with organizational policies.

For deployment, network device 220 may act as the execution controller, overseeing the deployment agent as it applies configuration changes, updates firmware, or modifies network routing policies. It continuously monitors real-time system logs, network performance indicators, and execution feedback to ensure that the deployment proceeds as planned. If issues arise, network device 220 may automatically trigger the Root Cause Analysis (RCA) module, which analyzes logs, identifies errors, and suggests or implements corrective actions. This component may also include rollback enforcement capabilities, helping ensure that any failed deployment can be safely reverted to its previous state. In addition to these core functions, network device 220 may support audit logging, compliance tracking, and performance analytics, providing a complete historical record of network changes, execution timestamps, and system responses. This data is valuable for continuous improvement, allowing the network automation framework to refine its processes over time through machine learning-based optimizations.

The network component 230 may be a target infrastructure element within the communications network that receives and implements the changes specified in the MOP. This component may represent any network device, system, or service that undergoes modifications as part of the network change management process. Broadly, network component 230 can encompass a wide range of physical and virtualized network entities, including routers, switches, firewalls, network controllers, load balancers, cloud-based services, edge computing nodes, or virtualized network functions (VNFs) deployed in a software-defined networking (SDN) or network function virtualization (NFV) environment.

Network component 230 may operate as the end recipient of configuration updates, software patches, security policy changes, or infrastructure optimizations performed through the MOP execution process. It may interface with the deployment agent of network device 220, which transmits execution commands, configuration scripts, or API calls to apply the prescribed changes. Depending on the nature of the modification, network component 230 may be dynamically reconfigured in real-time or undergo scheduled maintenance to ensure minimal disruption to active network operations. Additionally, this component may support redundancy and failover mechanisms, enabling high availability in case of deployment errors or rollback scenarios.

Network component 230 may also responsible for providing execution feedback and telemetry data, which is used to validate the success of the deployment. It may generate real-time system logs, status reports, and performance metrics, which are monitored by the orchestration framework and AI-driven Root Cause Analysis (RCA) agent in network device 220. If issues arise, network component 230 can signal failure events, configuration mismatches, or connectivity anomalies, prompting an automated rollback or corrective action sequence.

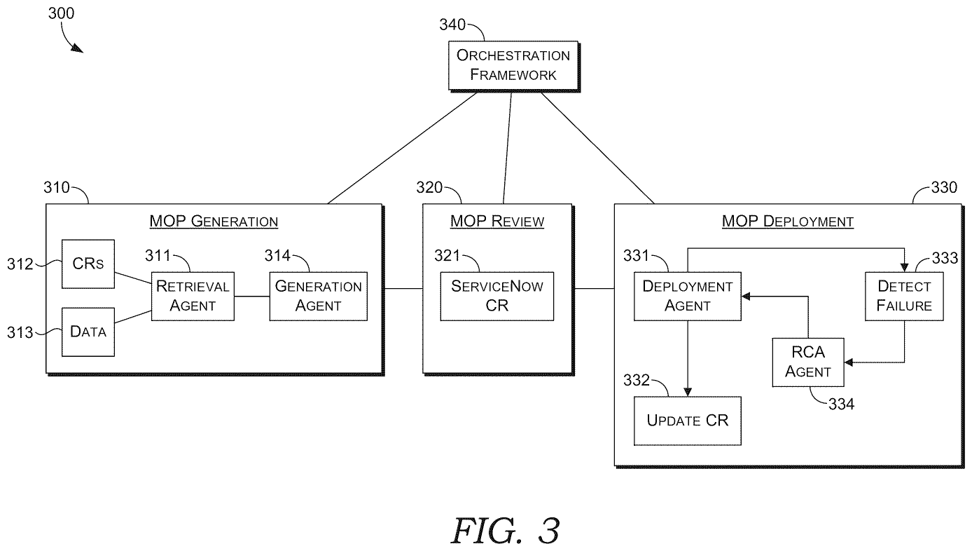

Turning now to FIG. 3, a flow diagram is illustrated in accordance with one or more aspects of the present disclosure. A flow diagram 300 may be said to exist between one or more components discussed in greater detail herein and is not meant to exhaustively show every interaction that would be necessary to practice the invention, so as not to obscure the present disclosure, but is instead meant to illustrate one or more potential interactions between components. The flow diagram 300 may be relevantly said to include a MOP Generation component 310 comprising a retrieval agent 311, CRs 312, Data 313, and a generation agent 314. The flow diagram 300 may further include a MOP Review component 320 comprising a ServiceNow CR 321. The flow diagram 300 may further include a MOP Deployment component comprising a deployment agent 331, an update CR 332, a failure detection 333, and an RCA agent 334. The flow diagram 300 may further include an orchestration framework 340. In some aspects, the components discussed may be the same or similar to the corresponding components from FIG. 2 discussed above.

The flow diagram 300 represents a structured and automated process for managing MOP execution in a communications network. The process is orchestrated through the orchestration framework 340, which serves as the central coordinating entity that manages the interactions between the MOP Generation component 310, MOP Review component 320, and MOP Deployment component 330. Each of these components plays a role in ensuring that network changes are systematically generated, reviewed, and deployed with minimal manual intervention.

The MOP Generation component 310 may be responsible for creating a structured MOP document based on relevant network data, CR details, and historical information. This component interacts with network management systems, configuration databases, and AI-driven agents to retrieve and process necessary data before formulating the procedural steps for network modifications. Once the MOP is generated, it is passed along to the MOP Review component 320 for validation.

The MOP Review component 320 may be tasked with evaluating the generated MOP to ensure its accuracy, completeness, and compliance with operational policies. This step is typically integrated with ServiceNow CR 321, where the review process is documented, approvals are tracked, and any necessary revisions are requested before proceeding. The orchestration framework 340 manages the transition of the MOP between generation and review, ensuring that any identified issues are addressed before deployment.

Once the MOP is approved, it may move into the MOP Deployment component 330, where the deployment agent 331 executes the prescribed network changes. This component interacts with the network infrastructure to apply the configuration updates, modify device settings, and monitor execution in real-time. The deployment process is continuously monitored for success or failure, with failure detection mechanisms 333 identifying potential issues during execution. If an error occurs, the RCA agent 334 analyzes logs and execution data to diagnose the root cause and recommend corrective actions. Updates to the ServiceNow CR 332 ensure that deployment progress and any necessary rollback actions are recorded.

The orchestration framework 340 may govern the process, helping ensure that each step transitions smoothly from generation to review and deployment. It synchronizes the operations of the individual components, triggers actions based on predefined conditions, and manages error handling and rollback procedures when necessary. By overseeing the interactions among these components, the orchestration framework 340 helps enable a seamless, automated, and resilient MOP execution process while reducing manual workload and mitigating the risk of human error.

The MOP Review component 320 may be responsible for validating the accuracy, completeness, and compliance of the MOP document before it proceeds to deployment. This component may act as a checkpoint, ensuring that the generated MOP is technically sound, follows operational best practices, and mitigates potential risks before execution. The orchestration framework 340 may trigger the review process once the MOP Generation component 310 has completed document creation.

A subcomponent within the MOP Review component 320 is the ServiceNow CR 321, which serves as the primary interface for tracking and managing the review process. The MOP document is automatically attached to its corresponding change request (CR) in ServiceNow, where it is assigned for review by AI-driven validation agents and, if necessary, by human operators. This integration ensures that all changes remain logged, auditable, and aligned with the organization's change management policies.

The review process involves multiple layers of validation. First, automated rule-based checks are performed to ensure that the MOP document includes all required sections, such as pre-check steps, implementation steps, post-check validations, and rollback procedures. The AI-driven validation system cross-references the MOP against historical execution data, identifying inconsistencies, missing steps, or deviations from best practices. Additionally, the system applies security and compliance policies, verifying that proposed changes adhere to encryption standards, firewall rules, and access control requirements.

If the AI-driven review detects issues, it flags them within the ServiceNow CR 321 notifying the responsible engineers for revision. In some cases, the system may suggest corrective actions based on historical data and previous successful MOPs. If manual intervention is required, review teams can provide feedback, request modifications, or escalate complex changes for further assessment.

Once the MOP document passes all validation checks and receives the necessary approvals, the orchestration framework 340 moves the document to the MOP Deployment component 330 for execution. By automating and structuring the review process, the MOP Review component 320 significantly reduces human workload, enhances document accuracy, and ensures that only verified MOPs proceed to deployment, thereby improving the overall reliability and security of network changes.

The MOP Deployment component 330 may be responsible for executing the validated MOP document, applying network changes, monitoring execution, detecting failures, and managing rollback or corrective actions if necessary. This component represents the final stage in the MOP process, where the planned modifications are implemented across the network infrastructure. Once the MOP Review component 320 approves the document, the orchestration framework 340 triggers the MOP Deployment component 330, ensuring a controlled and systematic execution.

Within the deployment process is the deployment agent 331, which directly interacts with network infrastructure components such as routers, switches, firewalls, load balancers, cloud services, or virtualized network functions (VNFs). The deployment agent 331 executes configuration updates, command-line instructions, API calls, and software installations as prescribed in the MOP. It operates in a structured manner, sequentially applying each step while continuously monitoring system responses, ensuring that the execution aligns with predefined success criteria.

As deployment progresses, real-time execution logs and system performance data are recorded in update CR 332, which is integrated with ServiceNow or another change management system. This integration allows for continuous tracking of the deployment status, including successful changes, pending actions, or encountered issues. The update CR 332 ensures that deployment progress remains visible and auditable, allowing engineers to monitor changes in real time.

A critical subcomponent of the MOP Deployment process is failure detection 333, which continuously monitors system behavior, execution logs, and network performance metrics. If an anomaly or failure is detected during deployment, such as a misconfiguration, device non-responsiveness, or performance degradation, the system automatically logs the event and halts further execution if necessary. This prevents cascading failures and allows the network to maintain operational stability.

When a failure is detected, the Root Cause Analysis (RCA) agent 334 is activated to diagnose the issue. The RCA agent 334 analyzes error logs, system responses, and historical failure data to identify the underlying cause of the deployment issue. Using machine learning-based anomaly detection and historical pattern recognition, the RCA agent 334 can suggest potential fixes or corrective actions. In some cases, it can automatically retry failed steps with adjusted parameters or recommend rollback procedures if the failure is deemed critical.

If a rollback is required, the orchestration framework 340 ensures that the rollback procedures outlined in the MOP document are executed systematically. This may involve reverting configuration changes, restoring previous system states, or reinstating backups. The rollback process is fully documented in the update CR 332, providing transparency and accountability.

By integrating automated execution, real-time monitoring, failure detection, and RCA-driven corrective actions, the MOP Deployment component 330 helps ensure that network changes are implemented in a controlled, reliable, and minimally disruptive manner. This structured approach reduces the risk of human error, enhances operational efficiency, and enables rapid recovery from deployment issues, ultimately improving the resilience and stability of the communications network.

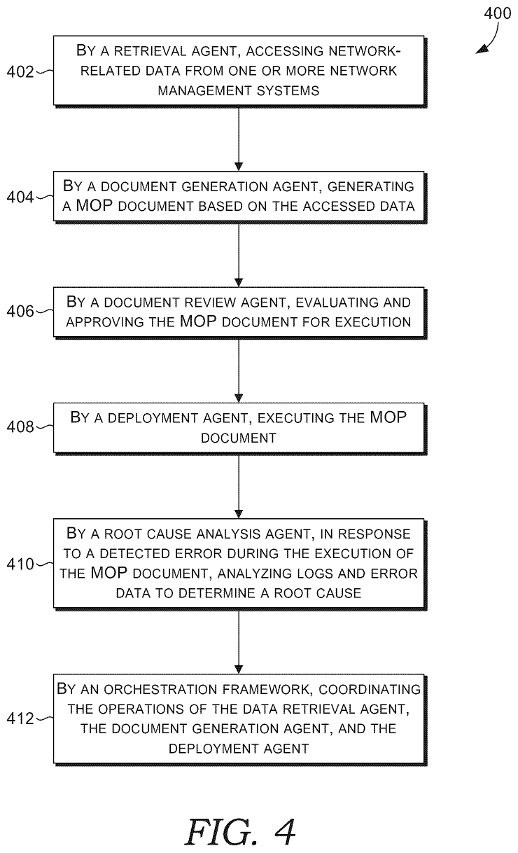

Turning now to FIG. 4, a flow chart is provided that illustrates one or more aspects of the present disclosure relating to a method 400 for generating, reviewing, and deploying Method of Procedure (MOP) data in a communications network. For example, at a first step 402, by a retrieval agent, network-related data from one or more network management systems is accessed. At a second step 404, by a document generation agent, a MOP document based on the accessed data is generated. At a third step 406, by a document review agent, the MOP document is evaluated and approved for execution. At a fourth step 408, by a deployment agent, the MOP document is executed. At a fifth step 410, by a root cause analysis agent, in response to a detected error during the execution of the MOP document, logs and error data are analyzed to determine a root cause. At a sixth step 412, by an orchestration framework, the operations of the data retrieval agent, the document generation agent, and the deployment agent are coordinated.

Many different arrangements of the various components depicted, as well as components not shown, are possible without departing from the scope of the claims below. Embodiments in this disclosure are described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

In the preceding detailed description, reference is made to the accompanying drawings which form a part hereof wherein like numerals designate like parts throughout, and in which is shown, by way of illustration, embodiments that may be practiced. It is to be understood that other embodiments may be utilized and structural or logical changes may be made without departing from the scope of the present disclosure. Therefore, the preceding detailed description is not to be taken in the limiting sense, and the scope of embodiments is defined by the appended claims and their equivalents.

1. A system for generating, reviewing, and deploying Method of Procedure (MOP) data in a communications network, the system comprising:
a network device comprising one or more processors; and
a non-transitory computer-readable medium comprising executable instructions that, when executed, cause the network device to perform operations in the communications network, comprising:
by a retrieval agent, accessing network-related data from one or more network management systems;
by a document generation agent, generating a MOP document based on the accessed data;
by an orchestration framework, in response to completion of generation of the MOP document, triggering a document review agent to review the MOP document;
by the document review agent, evaluating and approving the MOP document for execution;
by the orchestration framework, only in response to receipt of an approval indication for the MOP document, triggering a deployment agent to execute the MOP document;
by the deployment agent, executing the MOP document by directly interacting with a target network component through at least one of an application programming interface or a command-line interface to apply a network change prescribed by the MOP document;
by the orchestration framework, in response to receiving a failure indication during execution of the MOP document, triggering a root cause analysis agent;
by the root cause analysis agent, analyzing error logs, system responses, and historical failure data to determine a root cause and generate corrective-action feedback;
by the orchestration framework, providing the corrective-action feedback to the deployment agent; and
by the deployment agent, in response to the corrective-action feedback, retrying a failed step of the MOP document with an adjusted parameter.

2. The system of claim 1, wherein the document generation agent uses a tuned language model trained on domain-specific data to generate MOP documents tailored to the network's operational requirements.

3. The system of claim 1, wherein the document review agent performs compliance checks against predefined security policies, including encryption standards, access controls, and protocol configurations.

4. The system of claim 1, wherein the failed step comprises a failed command, and the deployment agent dynamically adjusts a parameter for the failed command and attempts execution of the failed command again before the orchestration framework triggers execution of a rollback procedure specified in the MOP document.

5. The system of claim 1, wherein the root cause analysis agent utilizes machine learning models to classify failures based on historical error patterns and suggest corrective actions.

6. The system of claim 1, wherein the orchestration framework prioritizes MOP processes based on network criticality, deployment urgency, or available resources.

7. The system of claim 1, further comprising:
by the orchestration framework, providing a status dashboard to display real-time updates and alerts for the accessing, generating, and executing processes.

8. The system of claim 1, wherein the network-related data comprises change request (CR) details for a requested network change, current configuration data for affected devices, and/or IP address or traffic information for newly introduced devices.

9. The system of claim 1, wherein the MOP document comprises instructions for pre-check procedures to validate the readiness of the network for the network change, implementation steps for applying the network change to network devices, post-check procedures to verify successful implementation, and rollback steps to restore the network to a prior state in case of a failure.

10. The system of claim 1, wherein executing the MOP document comprises performing pre-check procedures, applying implementation steps, monitoring real-time execution logs, and detecting deviations or errors during the execution of the MOP document.

11. One or more non-transitory computer-readable media having computer-executable instructions stored thereon that, when executed by one or more computer processing components, cause the one or more computer processing components to perform operations for generating, reviewing, and deploying Method of Procedure (MOP) data, the operations comprising:
by a retrieval agent, accessing network-related data from one or more network management systems;
by a document generation agent, generating a MOP document based on the accessed data;
by an orchestration framework, in response to completion of generation of the MOP document, triggering a document review agent to review the MOP document;
by the document review agent, evaluating and approving the MOP document for execution;
by the orchestration framework, only in response to receipt of an approval indication for the MOP document, triggering a deployment agent to execute the MOP document;
by the deployment agent, executing the MOP document by directly interacting with a target network component through at least one of an application programming interface or a command-line interface to apply a network change prescribed by the MOP document;
by the orchestration framework, in response to receiving a failure indication during execution of the MOP document, triggering a root cause analysis agent;
by the root cause analysis agent, analyzing error logs, system responses, and historical failure data to determine a root cause and generate corrective-action feedback;
by the orchestration framework, providing the corrective-action feedback to the deployment agent; and
by the deployment agent, in response to the corrective-action feedback, retrying a failed step of the MOP document with an adjusted parameter.

12. The media of claim 11, wherein the document generation agent uses a tuned language model trained on domain-specific data to generate MOP documents tailored to the network's operational requirements.

13. The media of claim 11, wherein the document review agent performs compliance checks against predefined security policies, including encryption standards, access controls, and protocol configurations.

14. The media of claim 11, wherein the failed step comprises a failed command, and the deployment agent dynamically adjusts a parameter for the failed command and attempts execution of the failed command again before the orchestration framework triggers execution of a rollback procedure specified in the MOP document.

15. The media of claim 11, wherein the root cause analysis agent utilizes machine learning models to classify failures based on historical error patterns and suggest corrective actions.

16. The media of claim 11, wherein the orchestration framework prioritizes MOP processes based on network criticality, deployment urgency, or available resources.

17. The media of claim 11, further comprising:
by the orchestration framework, providing a status dashboard to display real-time updates and alerts for the accessing, generating, and executing processes.

18. The media of claim 11, wherein the network-related data comprises change request (CR) details for a requested network change, current configuration data for affected devices, and/or IP address or traffic information for newly introduced devices.

19. The media of claim 11, wherein the MOP document comprises instructions for pre-check procedures to validate the readiness of the network for the network change, implementation steps for applying the network change to network devices, post-check procedures to verify successful implementation, and rollback steps to restore the network to a prior state in case of a failure.

20. A method performed by a network device for generating, reviewing, and deploying Method of Procedure (MOP) data, the method comprising:
by a retrieval agent, accessing network-related data from one or more network management systems;
by a document generation agent, generating a MOP document based on the accessed data;
in response to completion of generation of the MOP document, triggering, by an orchestration framework, a document review agent to review the MOP document;
by the document review agent, evaluating and approving the MOP document for execution;
only in response to receipt of an approval indication for the MOP document, triggering, by the orchestration framework, a deployment agent to execute the MOP document;
executing, by the deployment agent, the MOP document by directly interacting with a target network component through at least one of an application programming interface or a command-line interface to apply a network change prescribed by the MOP document;
in response to receiving a failure indication during execution of the MOP document, triggering, by the orchestration framework, a root cause analysis agent;
analyzing, by the root cause analysis agent, error logs, system responses, and historical failure data to determine a root cause and generate corrective-action feedback;
providing, by the orchestration framework, the corrective-action feedback to the deployment agent; and
in response to the corrective-action feedback, retrying, by the deployment agent, a failed step of the MOP document with an adjusted parameter.
